(19) United States
(12) Patent Application Publication
(10) Pub. No.: US 2018/0329330 A1
(43) Pub. Date: Nov. 15, 2018

(54) ELECTROPHOTOGRAPHIC TONER SET, IMAGE FORMING APPARATUS, AND IMAGE FORMING METHOD

(71) Applicant: TOSHIBA TEC KABUSHIKI KAISHA, Tokyo (JP)

(72) Inventors: Yusuke Era, Mishima (JP); Masahiro Ikuta, Kannami Tagata (JP); Kazuhisa Takeda, Kannami Tagata (JP); Tsuyoshi Itou, lzunokuni (JP); Takafumi Hara, Nagaizumi Sunto (JP)

(73) Assignee: TOSHIBA TEC KABUSHIKI KAISHA, Tokyo (JP)

(21) Appl. No.: 15/836,480

(22) Filed: Dec. 8, 2017

(30) Foreign Application Priority Data
May 11, 2017 (JP) 2017-094872

(51) Int. Cl. G03G 9/00; G03G 9/097; G03G 9/09

(52) U.S. Cl. CPC G03G 9/09716; G03G 9/0906; G03G 9/09783

(57) ABSTRACT

An electrophotographic toner set, an image forming apparatus, and an image forming method include a developer toner and a replenishment toner. The developer toner and the replenishment toner each include toner particles, and silica particles and titania particles provided on the surfaces of the toner particles. The silica particles have a BET specific surface area of 15 to 95 m²/g and are surface-treated with a silicone oil. The relationship between the content of the silica particles of the developer toner and the content of the silica particles of the replenishment toner, and the relationship between the content of the titania particles of the developer toner and the content of the titania particles of the replenishment toner each have particular values.

### CROSS-REFERENCE TO RELATED APPLICATION

This application is based upon and claims the benefit of priority from Japanese Patent Application No. 2017-094872, filed May 11, 2017, the entire contents of which are incorporated herein by reference.

### FIELD

Embodiments described herein relate to a toner set including toners to be used in electrophotography, an image forming apparatus, and an image forming method using the same.

### BACKGROUND

Heretofore, as an image forming method, an electrophotographic method in which an electrical latent image is formed on an image carrier, and then, the latent image is developed with a toner is used. After developing the latent image, a toner image is transferred onto a transfer material such as paper, followed by fixing by heating, pressing, etc. As the toner used here, in order to form a full color image, not only a conventional toner of a single color of black, but also toners of a plurality of colors are used to form an image.

Toner particles used in the electrophotographic method are required to maintain a specific preferred charge amount. When the charge amount of the toner is lower than the specific preferred charge amount, the toner particles are scattered from a developing device, an image density is higher than the desired image density when printing, or fixing failure occurs in some cases. However, as the number of passing paper sheets is increased for utilizing an image forming apparatus, the carrier in the developer is deteriorated, and therefore, the charge amount of the toner tends to decrease. Further, the amount of water adhered to the toner particles was increased in a high humidity environment, and water coming into contact with the toner particles caused leakage of electric charge of the toner particles so as to decrease the charge amount in some cases.

In order to prevent these problems, a technique in which a certain amount or more of charge amount is imparted to the toner particles in anticipation of the decrease in the charge amount of the toner due to the use described above is also being examined.

However, on the other hand, when the charge amount of the toner was increased, immediately after starting use, the charge amount of the toner was higher than the above-mentioned specific preferred charge amount in some cases. When the charge amount of the toner was higher than the above-mentioned specific preferred charge amount, the image density when printing did not reach a desired density in some cases.

An object of embodiments herein is to provide an electrophotographic toner set and an image forming method capable of preventing scattering of toner particles or fixing failure, and also maintaining a constant image density by maintaining the charge amount of the toner at a fixed level regardless of the printing environment and also even if printing is repeated.

An electrophotographic toner set, an image forming apparatus, and an image forming method according to embodiments include a developer toner and a replenishment toner. The developer toner and the replenishment toner each include toner particles, and silica particles and titania particles provided on the surfaces of the toner particles. The silica particles have a BET specific surface area of 15 to 95 m²/g and are surface-treated with a silicone oil. The titania particles have a BET specific surface area of 30 to 65 m²/g. The content W_{S1} (parts by mass) of the silica particles with respect to 100 parts by mass of the toner particles of the developer toner and the content W_{S2} (parts by mass) of the silica particles per total mass of the replenishment toner satisfy the following relationship: 0.5≤(W_{S1}/W_{S2})<1.0. The content W_{T1} (parts by mass) of the titania particles with respect to 100 parts by mass of the toner particles of the developer toner and the content W_{T2} (parts by mass) of the titania particles per total mass of the replenishment toner satisfy the following relationship: 1.0<(W_{T1}/W_{T2})≤5.0.

### DESCRIPTION OF THE DRAWINGS

FIG. 1 is a side view showing an image forming apparatus according to one embodiment.

### DETAILED DESCRIPTION

Hereinafter, an electrophotographic toner set, an image forming apparatus, and an image forming method according to embodiments will be described with reference to the drawing.

### (Configuration of Developer Toner)

An electrophotographic toner set of an embodiment includes a developer toner and a replenishment toner.

First, the configuration of the developer toner containing the below-mentioned components will be described.

The developer toner is a toner to be added to a developer at an initial developing stage. Specifically, the developer toner of this embodiment refers to a toner mixed with a carrier as a developer from an initial stage of use of an image forming apparatus.

The developer toner includes toner particles, silica particles, and titania particles.

### (Toner Particles)

The toner particles are particles containing a colorant. In this embodiment, the toner particles contain at least a colorant containing a color developable compound and a color developing agent. Further, the toner particles preferably contain microcapsules (capsular particles having a diameter in the order of micrometers) which include the colorant and a decolorizing agent described below as core components and a resin as a shell component. By forming the toner particles into microcapsules, the coloring and decolorizing activity is improved. Further, by using the toner particles as microcapsules, the effect of the chemical activity of other toner materials on the color developable compound, the color developing agent, and the decolorizing agent is prevented.

The volume average particle diameter of the microcapsules is preferably from 0.10 to 10 μm, more preferably from 0.5 to μm. When the volume average particle diameter of the microcapsules is 0.10 μm or more, a coloring ability can be increased. Further, when the volume average particle diameter of the microcapsules is 10 μm or less, the particle diameter of the toner does not become too large, and a favorable image quality is easily obtained when the toner is used by mixing with a color material.

The volume average particle diameter of the microcapsules is preferably from 1 to 70%, more preferably from 10 to 50% of the volume average particle diameter (generally from 3 to 20 μm, preferably from 3 to 15 μm) of the toner particles.

The shape of the microcapsule can be selected as appropriate. According to the above-mentioned volume average particle diameter, the volume D₅₀ of the microcapsules is preferably from 0.3 to 3.5 μm.

Examples of the resin as the shell component include a urea-formaldehyde resin, a melamine-formaldehyde resin, a guanamine-formaldehyde resin, a sulfonamide-aldehyde resin, and an aniline-formaldehyde resin. From the viewpoint of excellent water resistance, chemical resistance, solvent resistance, and aging resistance, melamine-formaldehyde resin is preferred as the resin.

The content ratio of the resin for forming a wall film in the microcapsule is set to preferably 0.1 to 1 part by mass, more preferably 0.2 to 0.5 parts by mass with respect to 1 part by mass of the contents.

The content ratio of the microcapsules is set to preferably 0.5 to 30 parts by mass, more preferably 1 to 15 parts by mass with respect to 100 parts by mass of the toner particles.

The color developable compound is a precursor compound of a dye for displaying letters, figures, etc. As the color developable compound, a leuco dye can be mainly used. A leuco dye-based color developable compound is an electron donating compound having a characteristic such that the compound is colored when associating with the below-mentioned color developing agent, and is decolorized when dissociating from the color developing agent. Examples thereof include diphenylmethane phthalides, phenylindolyl phthalides, indolyl phthalides, diphenylmethane azaphthalides, phenylindolyl azaphthalides, fluorans, styrynoquinolines, and diaza-rhodamine lactones.

Specific examples thereof include 3,3-bis(p-dimethylaminophenyl)-6-dimethylaminophthalide, 3-(4-diethylaminophenyl)-3-(1-ethyl-2-methylindol-3-yl)phthalide, 3,3-bis(1-n-butyl-2-methylindol-3-yl)phthalide, 3,3-bis(2-ethoxy-4-diethylaminophenyl)-4-azaphthalide, 3-(2-ethoxy-4-diethylaminophenyl)-3-(1-ethyl-2-methylindol-3-yl)-4-azaphthalide, 3-[2-ethoxy-4-(N-ethylanilino)phenyl]-3-(1-ethyl-2-methylindol-3-yl)-4-azaphthalide, 3,6-diphenylaminofluoran, 3,6-dimethoxyfluoran, 3,6-di-n-butoxyfluoran, 2-methyl-6-(N-ethyl-N-p-tolylamino)fluoran, 2-N,N-dibenzylamino-6-diethylaminofluoran, 3-chloro-6-cyclohexylaminofluoran, 2-methyl-6-cyclohexylaminofluoran, 2-(2-chloroanilino)-6-di-n-butylaminofluoran, 2-(3-trifluoromethylanilino)-6-diethylaminofluoran, 2-(N-methylanilino)-6-(N-ethyl-N-p-tolylamino)fluoran, 1,3-dimethyl-6-diethylaminofluoran, 2-chloro-3-methyl-6-diethylaminofluoran, 2-anilino-3-methyl-6-diethylaminofluoran, 2-anilino-3-methyl-6-di-n-butylaminofluoran, 2-xylidino-3-methyl-6-diethylaminofluoran, 1,2-benz-6-diethylaminofluoran, 1,2-benz-6-(N-ethyl-N-isobutylamino)fluoran, 1,2-benz-6-(N-ethyl-N-isoamylamino)fluoran, 2-(3-methoxy-4-dodecoxystyryl)quinoline, spiro[5H-(1)benzopyrano(2,3-d)pyrimidine-5,1′(3′H)isobenzofuran]-3′-one, 2-(diethylamino)-8-(diethylamino)-4-methyl-, spiro[5H-(1)benzopyrano(2,3-d)pyrimidine-5,1′(3′H)isobenzofuran]-3′-one, 2-(di-n-butylamino)-8-(di-n-butylamino)-4-methyl-, spiro[5H-(1)benzopyrano(2,3-d)pyrimidine-5,1′(3′H)isobenzofuran]-3′-one, 2-(di-n-butylamino)-8-(diethylamino)-4-methyl-, spiro[5H-(1)benzopyrano(2,3-d)pyrimidine-5,1′(3′H)isobenzofuran]-3′-one, 2-(di-n-butylamino)-8-(N-ethyl-N-i-amylamino)-4-methyl-, spiro[5H-(1)benzopyrano(2,3-d)pyrimidine-5,1′(3′H)isobenzofuran]-3′-one, 2-(di-n-butylamino)-8-(di-n-butylamino)4-phenyl, 3-(2-methoxy-4-dimethylaminophenyl)-3-(1-butyl-2-methylindol-3-yl)-4,5,6,7-tetrachlorophthalide, 3-(2-ethoxy-4-diethylaminophenyl)-3-(1-ethyl-2-methylindol-3-yl)-4,5,6,7-tetrachlorophthalide, and 3-(2-ethoxy-4-diethylaminophenyl)-3-(1-pentyl-2-methylindol-3-yl)-4,5,6,7-tetrachlorophthalide. Additional examples thereof include pyridine compounds, quinazoline compounds, and bisquinazoline compounds.

As the color developable compound, one type may be used alone or two or more types may be used in combination.

The color developing agent is an electron accepting compound which donates a proton to the color developable compound (which accepts an electron from the color developable compound).

Examples of the color developing agent include phenols, metal salts of phenols, metal salts of carboxylic acids, aromatic carboxylic acids, aliphatic carboxylic acids having 2 to 5 carbon atoms, benzophenones, sulfonic acids, sulfonates, phosphoric acids, metal salts of phosphoric acids, acidic phosphoric acid esters, metal salts of acidic phosphoric acid esters, phosphorous acids, metal salts of phosphorous acids, monophenols, polyphenols, 1,2,3-triazole, and derivatives thereof. Additional examples thereof include those having, as a substituent, an alkyl group, an aryl group, an acyl group, an alkoxycarbonyl group, a carboxy group or an ester thereof, an amide group, a halogen group, or the like, and bisphenols, trisphenols, phenol-aldehyde condensed resins, and metal salts thereof.

Specific examples thereof include phenol, o-cresol, t-butyl catechol, nonylphenol, n-octylphenol, n-dodecylphenol, n-stearylphenol, p-chlorophenol, p-bromophenol, o-phenylphenol, n-butyl p-hydroxybenzoate, n-octyl p-hydroxybenzoate, benzyl p-hydroxybenzoate, dihydroxybenzoic acid and esters thereof (such as 2,3-dihydroxybenzoic acid and methyl 3,5-dihydroxybenzoate), resorcin, gallic acid, dodecyl gallate, ethyl gallate, butyl gallate, propyl gallate, 2,2-bis(4-hydroxyphenyl)propane, 4,4-dihydroxydiphenylsulfone, 1,1-bis(4-hydroxyphenyl)ethane, 2,2-bis(4-hydroxy-3-methylphenyl)propane, bis(4-hydroxyphenyl)sulfide, 1-phenyl-1,1-bis(4-hydroxyphenyl)ethane, 1,1-bis(4-hydroxyphenyl)-3-methylbutane, 1,1-bis(4-hydroxyphenyl)-2-methylpropane, 1,1-bis(4-hydroxyphenyl)n-hexane, 1,1-bis(4-hydroxyphenyl)n-heptane, 1,1-bis(4-hydroxyphenyl)n-octane, 1,1-bis(4-hydroxyphenyl)n-nonane, 1,1-bis(4-hydroxyphenyl)n-decane, 1,1-bis(4-hydroxyphenyl)n-dodecane, 2,2-bis(4-hydroxyphenyl)butane, 2,2-bis(4-hydroxyphenyl) ethyl propionate, 2,2-bis(4-hydroxyphenyl)-4-methylpentane, 2,2-bis(4-hydroxyphenyl)hexafluoropropane, 2,2-bis(4-hydroxyphenyl)n-heptane, 2,2-bis(4-hydroxyphenyl)n-nonane, 2,4-dihydroxyacetophenone, 2,5-dihydroxyacetophenone, 2,6-dihydroxyacetophenone, 3,5-dihydroxyacetophenone, 2,3,4-trihydroxyacetophenone, 2,4-dihydroxybenzophenone, 4,4′-dihydroxybenzophenone, 2,3,4-trihydroxybenzophenone, 2,4,4′-trihydroxybenzophenone, 2,2′,4,4′-tetrahydroxybenzophenone, 2,3,4,4′-tetrahydroxybenzophenone, 2,4′-biphenol, 4,4′-biphenol, 4-[(4-hydroxyphenyl)methyl]-1,2,3-benzenetriol, 4-[(3,5-dimethyl-4-hydroxyphenyl)methyl]-1,2,3-benzenetriol, 4,6-bis[(3,5-dimethyl-4-hydroxyphenyl)methyl]-1,2,3-benzenetriol, 4,4′-[1,4-phenylenebis(1-methylethylidene)bis(benzene-1,2,3-triol)], 4,4′-[1,4-phenylenebis(1-methylethylidene)bis(1,2-benzenediol)], 4,4′,4″-ethylidenetrisphenol, 4,4′-(1-methylethylidene)bisphenol, and methylenetris-p-cresol. As the color developing agent, one type may be used alone, or two or more types may be used in combination.

The content of the color developing agent in the colorant is preferably from 10 to 10000 parts by mass, more preferably from 10 to 5000 parts by mass, further more preferably from 50 to 2000 parts by mass with respect to 100 parts by mass of the color developable compound.

The microcapsules of this embodiment may further contain a decolorizing agent. As the decolorizing agent, any known decolorizing agent can be used as long as in a three-component system of the color developable compound, the color developing agent, and the decolorizing agent, the decolorizing agent can make the system colorless by inhibiting the coloring reaction between the color developable compound and the color developing agent by heat. Examples of the form of the decolorizing agent include a form in which a component which is colored by associating the color developable compound with the color developing agent, and a component of the decolorizing agent are dispersed in a medium which has low or no coloring and decolorizing activity, and a form in which a component of the decolorizing agent is used as a medium of a component which is colored by associating the color developable compound with the color developing agent.

As the decolorizing agent to be used in the latter form, particularly, a material known in JP-A-60-264285, JP-A-2005-1369, JP-A-2008-280523, etc. can be used. A coloring and decolorizing mechanism utilizing the temperature hysteresis of a discoloring temperature control agent has an excellent instantaneous erasing property. In this mechanism, by using a substance which has a large temperature difference between the melting point and the solidifying point called “discoloring temperature control agent” as the decolorizing agent, decolorization occurs when performing heating to a temperature equal to or higher than the melting point of the discoloring temperature control agent, and the decolorized state is maintained until the solidifying point is reached. When the solidifying point is equal to and lower than normal temperature, the color material maintains the decolorized state even at normal temperature.

That is, when a mixture (color material) of such a three-component system in a colored state is heated to a specific decolorizing temperature (Th) or higher, the mixture can be decolorized, and even if the decolorized mixture is cooled to a temperature equal to or lower than Th, the decolorized state is maintained. When the temperature of the mixture is further decreased, the coloring reaction between the color developable compound and the color developing agent is restored again at a specific color restoring temperature (Tc) or lower, and the mixture returns to a colored state. In this manner, reversible coloring and decolorizing reactions can be caused. In particular, the discoloring temperature control agent to be used in this embodiment preferably satisfies the following relationship: Th>Tr>Tc, wherein Tr represents room temperature.

Examples of the discoloring temperature control agent capable of causing such temperature hysteresis include alcohols, esters, ketones, ethers, and acid amides, which are known in the above-mentioned Patent Documents. Among these, esters are particularly preferred.

Specific examples thereof include esters of a carboxylic acid containing a substituted aromatic ring, esters of a carboxylic acid containing an unsubstituted aromatic ring with an aliphatic alcohol, esters of a carboxylic acid containing a cyclohexyl group in a molecule, esters of a fatty acid with an unsubstituted aromatic alcohol or a phenol, esters of a fatty acid with a branched aliphatic alcohol, esters of a dicarboxylic acid with an aromatic alcohol or a branched aliphatic alcohol, dibenzyl cinnamate, heptyl stearate, didecyl adipate, dilauryl adipate, dimyristyl adipate, dicetyl adipate, distearyl adipate, trilaurin, trimyristin, tristearin, dimyristin, and distearin.

As the decolorizing agent, one type may be used alone, or two or more types may be used in combination.

The content of the decolorizing agent in the colorant is preferably from 100 to 80000 parts by mass, more preferably from 500 to 20000 parts by mass, furthermore preferably from 500 to 10000 parts by mass with respect to 100 parts by mass of the color developable compound.

The colorant may contain another component in addition to the color developable compound, the color developing agent, and the decolorizing agent as needed.

The content of the colorant is preferably 5 to 60 mass %, more preferably 15 to 60 mass % with respect to the total amount (excluding the below-mentioned external additive) of the toner. When the content of the colorant is less than the above preferred lower limit, the coloring property of the toner is hardly exhibited. When the content of the colorant exceeds the above preferred upper limit, the fixability and the image robustness are likely to be deteriorated.

### (Silica Particles)

As the silica particles contained in the developer toner of this embodiment, silica particles that satisfy the below-mentioned conditions of the average primary particle diameter and the BET specific surface area can be selected as appropriate. As such silica particles, fumed silica particles are preferably used. The fumed silica particles are silica particles produced by, for example, combustion hydrolysis at a high temperature.

As the silica particles of this embodiment, silica particles having an average primary particle diameter of 16 to 40 nm are desirably used. The average primary particle diameter can be measured by a known method. For example, a value obtained by calculating the average primary particle diameter from the particle diameter using any of a variety of particle size distribution analyzers can be used. In this embodiment, a value measured using SALD-7000 manufactured by Shimadzu Corporation is adopted.

When the average primary particle diameter of the silica particles is equal to or more than the above lower limit, the image density does not decrease when forming an image due to an excessive increase in the charge amount of the toner. When the average primary particle diameter of the silica particles is equal to or less than the above upper limit, the image density does not increase when forming an image due to an excessive decrease in the charge amount of the toner.

The silica particles of this embodiment have a BET specific surface area of preferably 15 to 95 m²/g, more preferably 20 to 40 m²/g.

Here, the BET specific surface area can be measured in accordance with JIS Z 8830. As the measurement device, for example, an automatic specific surface area and pore size distribution analyzer, TriStar 3000 (manufactured by Shimadzu Corporation) is used. In the measurement, a toner sample in an amount of 1.0 g is sufficiently degassed at 20° C. over 4 hours under vacuum conditions, and the BET specific surface area is measured using N₂ gas as an adsorption gas.

When the BET specific surface area of the silica particles is equal to or more than the above lower limit, the image density does not increase when forming an image due to an excessive decrease in the charge amount of the toner. When the BET specific surface area of the silica particles is equal to or less than the above upper limit, the image density does not decrease when forming an image due to an excessive increase in the charge amount of the toner.

The silica particles are surface-treated with a silicone oil. In this embodiment, as the silicone oil, polydimethylsiloxane (PDMS) is used.

As the silica particles surface-treated with a silicone oil, commercially available PDMS-treated silica particles may be used. Examples of the commercially available PDMS-treated silica particles include NY-50, RY-50, and NY-90L manufactured by Aerosil Co., Ltd., H05TD and H13TD manufactured by Wacker Co., Ltd., TG-5180 and TG-5185F manufactured by Cabot Co., Ltd., and PM-05 and PM-09 manufactured by Tokuyama Co., Ltd.

By surface-treating the silica particles with a silicone oil, the hydrophobicity of the toner is increased. Therefore, the amount of water absorbed by the toner particles is reduced, and the leakage of electric charge to water molecules is prevented, and thus, the charge amount of the toner can be further maintained. In particular, an effect of suppressing a decrease in the charge amount even in the image formation in a high humidity environment in which a decrease in the charge amount is likely to occur conventionally is obtained.

Further, silica particles other than the silica particles surface-treated with PDMS can also be used as needed. For example, silica particles surface-treated with hexamethyldisilazane (HMDS) or the like are also added as needed. In this embodiment, the silica particles surface-treated with PDMS are desirably contained in an amount of 55% or more because of having a high effect of increasing the charge amount of the toner among the silica particles.

The silica particles contained in the developer toner of this embodiment are preferably added to the toner particles as an external additive described below.

### (Titania Particles)

The titania particles contained in the developer toner of this embodiment widely refer to titanium oxide particles. As the titania particles, titania particles that satisfy the below-mentioned conditions of the average primary particle diameter and the BET specific surface area can be selected as appropriate. The titania particles are desirably titania particles surface-treated with an alkylsilane (RS).

The average primary particle diameter of the titania particles of this embodiment is desirably from 10 to 20 nm. The average primary particle diameter can be measured by the above-mentioned known method.

When the average primary particle diameter of the titania particles of this embodiment is equal to or more than the above lower limit, the image density does not decrease when forming an image due to an excessive increase in the charge amount of the toner. When the average primary particle diameter of the titania particles is equal to or less than the above upper limit, the image density does not increase when forming an image due to an excessive decrease in the charge amount of the toner.

The titania particles of this embodiment have a BET specific surface area of preferably 30 to 80 m²/g, more preferably 50 to 80 m²/g. Here, the BET specific surface area can be measured in the same manner as the silica particles described above. Examples of the titania particles include STT-30S manufactured by Titan Kogyo, Ltd., JMT-150IB and JMT-150AO manufactured by TAYCA CORPORATION, and NKT90 and NKT65 manufactured by Nippon Aerosil Co., Ltd.

When the BET specific surface area of the titania particles is equal to or more than the above lower limit, the image density does not increase when forming an image due to an excessive decrease in the charge amount of the toner. When the BET specific surface area of the titania particles is equal to or less than the above upper limit, the image density does not decrease when forming an image due to an excessive increase in the charge amount of the toner.

The titania particles contained in the developer toner of this embodiment are preferably added to the toner particles as an external additive described below.

### (Binder Resin)

The developer toner of this embodiment contains a binder resin in addition to the above-mentioned components.

The binder resin of this embodiment can be appropriately selected from various known resins to be used in the toner. As the binder resin of this embodiment, a polyester resin which has favorable fixability and also has little effect on aroma is preferred. Further, among the polyester resins, a polyester resin having an acid value of 1 mg KOH/g or more is preferred. If the acid value of the polyester resin is equal to or more than the above lower limit, when the binder resin is formed into particles, the dispersibility of the particles is increased. In particular, in the below-mentioned aggregation method, a dispersion liquid of particles having a small particle diameter is easily obtained when an alkaline pH adjusting agent is added. As the binder resin, one type may be used alone or two or more types may be used in combination.

In addition to the binder resin, any known assist agent to be used when the binder resin is polymerized such as a chain transfer agent, a crosslinking agent, a polymerization initiator, a surfactant, an aggregating agent, a pH adjusting agent, or a defoaming agent may be added.

### (Other Additives)

The developer toner of this embodiment may contain other additives in addition to the above-mentioned configuration.

Examples of the other additives include a release agent, a charge control agent, an antioxidant, and a colorant other than the above-mentioned toner particles. These may be appropriately selected from known additives to be used in a conventional toner, and one type or a plurality of types may be used.

### (Contents of Silica Particles and Titania Particles of Developer Toner)

In the developer toner, the contents of the silica particles and the titania particles described above satisfy a specific relationship with the contents of the silica particles and the titania particles of the replenishment toner described below.

That is,

(1) the content W_{S1} of the silica particles of the developer toner and the content W_{S2} of the silica particles of the replenishment toner satisfy the following relationship: 0.5≤(W_{S1}/W_{S2})<1.0, and

(2) the content W_{T1} of the titania particles of the developer toner and the content W_{T2} of the titania particles of the replenishment toner satisfy the following relationship: 1.0<(W_{T1}/W_{T2})≤5.0.

Further, the contents of the silica particles of the developer toner and the replenishment toner preferably satisfy the following relationship: 0.7≤(W_{S1}/W_{S2})≤0.9. Alternatively, the contents of the titania particles of the developer toner and the replenishment toner preferably satisfy the following relationship: 2.3≤(W_{T1}/W_{T2})≤3.3. In addition, it is more preferred to satisfy these relationships with respect to the silica particles and the titania particles.

Further, in the developer toner, the content W_{S1} of the silica particles and the content W_{T1} of the titania particles preferably satisfy the following relationship: 0.5<(W_{S1}/W_{T1})≤5.0. When the value of W_{S1}/W_{T1} is within the above range, the charge amount of the toner at an initial developing stage can be maintained at a fixed level or more.

### (External Additive)

The developer toner of this embodiment preferably includes the toner particles and an external additive. In this embodiment, the external additive includes a silica particle external additive containing silica particles and a titania particle external additive containing titania particles.

The external additive is added for improving the fluidity, chargeability, and stability during storage of the developer toner. As the external additive, an external additive containing particles composed of an inorganic oxide may be used in addition to the silica particle external additive and the titania particle external additive. As the inorganic oxide, for example, particles of an inorganic oxide such as silica other than the above-mentioned silica, a titanium compound other than the above-mentioned titanium compound, alumina, strontium titanate, or tin oxide can be used alone or by mixing two or more types thereof. Further, the particles composed of an inorganic oxide may be surface-treated with a hydrophobizing agent from the viewpoint of improvement of stability.

The volume average particle diameter of the particle groups of the particles composed of an inorganic oxide is not particularly limited, but is preferably in a range of 8 to 200 nm. When the volume average particle diameter of the particle groups of the particles is less than the above lower limit, the toner transfer efficiency for a transfer belt or paper may be deteriorated. When the volume average particle diameter of the particle groups of the particles exceeds the above upper limit, a photoconductor may be damaged or the like.

The addition amount of the particles composed of an inorganic oxide other than the above-mentioned silica particles and titania particles may be from 0.01 to 20 mass % with respect to the total mass of the toner.

To the developer toner, resin fine particles or a metal soap may be externally added in addition to the above-mentioned particles composed of an inorganic oxide. As the resin fine particles, those having a size of 1 μm or less are preferably used.

A method for adding the external additive will be described.

The external additive is, for example, mixed with the developer toner using a mixer. Examples of the mixer include the same mixers as used in the method for producing the developer toner.

The external additive may be sieved using a sieving device so as to sieve out coarse particles or the like as needed. As the sieving device, a known sieving device can be used.

### (Configuration of Replenishment Toner)

Next, the configuration of the replenishment toner containing the above-mentioned components will be described.

The replenishment toner is a toner to be added to a developer at a stage other than the initial developing stage. Specifically, the replenishment toner of this embodiment refers to a toner which is replenished from a replenishment cartridge in an amount corresponding to the reduced amount of the toner in the originally existing developer reduced by printing.

The replenishment toner includes toner particles, silica particles, and titania particles in the same manner as the above-mentioned developer toner.

The replenishment toner may be selected from the same configuration as that of the above-mentioned developer toner other than adjustment of the contents of the silica particles and the titania particles as described below. That is, with respect to the composition of the components of the silica particles and the titania particles and the composition and the contents of other components, the replenishment toner may have the same configuration as that of the above-mentioned developer toner. Alternatively, with respect to each component, the replenishment toner may have another configuration appropriately selected from the above-mentioned examples.

### (Contents of Silica Particles and Titania Particles of Replenishment Toner)

As described above, the contents of the silica particles and the titania particles of the replenishment toner satisfy a specific relationship with the contents of the silica particles and the titania particles of the above-mentioned developer toner.

That is, in the same manner as described above,

(1) the content W_{S1} of the silica particles of the developer toner and the content W_{S2} of the silica particles of the replenishment toner satisfy the following relationship: 0.5≤(W_{S1}/W_{S2})<1.0, and

(2) the content W_{T1} of the titania particles of the developer toner and the content W_{T2} of the titania particles of the replenishment toner satisfy the following relationship: 1.0<(W_{T1}/W_{T2})≤5.0.

Further, the contents of the silica particles of the developer toner and the replenishment toner preferably satisfy the following relationship: 0.7≤(W_{S1}/W_{S2})≤0.9. Alternatively, the contents of the titania particles of the developer toner and the replenishment toner preferably satisfy the following relationship: 2.3≤(W_{T1}/W_{T2})≤3.3. In addition, it is more preferred to satisfy these relationships with respect to the silica particles and the titania particles.

Further, in the replenishment toner, the content W_{S2} of the silica particles and the content W_{T2} of the titania particles preferably satisfy the following relationship: 6.0<(W_{S2}/W_{T2})<8.0. When the value of W_{S2}/W_{T2} is within the above range, even if printing is continued, the charge amount of the toner can be maintained in a specific range, and a favorable print density can be obtained.

### (Configuration of Electrophotographic Toner Set)

The electrophotographic toner set of this embodiment includes the developer toner and the replenishment toner. The specific configuration of this electrophotographic toner set can be selected as appropriate.

For example, with respect to the supply form of each toner, the developer toner and the replenishment toner may be each supplied to the below-mentioned toner cartridge. Alternatively, the developer toner and the replenishment toner may be configured by various containers filled with each toner. In this case, each toner may be configured to be replenished at any time to an image forming apparatus or a toner cartridge from the container.

The combination of the respective toners may be configured such that the developer toner is initially supplied to the image forming apparatus, and the amount of replenishment toner to be replenished thereafter is set larger.

The electrophotographic toner set may include another constituent element in addition to the developer toner and the replenishment toner, for example, a tool for use in supplying the toner, or another constituent element to be used in the image forming apparatus.

### (Effect of Electrophotographic Toner Set)

According to the electrophotographic toner set of at least one embodiment described above, the proportion of the titania particles having low electronegativity in the toner in the developer is increased, and therefore, the printing amount is increased. To the replenishment toner to be replaced for the toner in the developer, a form in which the proportion of the silica particles having high electronegativity and surface-treated with a silicone oil is increased is applied.

That is, in a low humidity environment or at a stage where the printing amount is small, in which the charge amount of the toner particles tends to high, by increasing the proportion of the titania particles having low electronegativity in the external additive, the charge amount of the toner can be decreased. On the other hand, in a high humidity environment or at a stage in which the printing amount is increased and the charge amount of the toner particles tends to decrease, by increasing the proportion of the silica particles having high electronegativity in the external additive, the charge amount of the toner can be increased.

Further, as the silica particles to be used in this embodiment, silica particles in which the hydrophobicity of the toner particles is increased by performing a surface treatment with a silicone oil are used. Due to this, even in image formation in a high humidity environment, by reducing the amount of water absorbed by the toner particles, leakage of electric charge to water molecules adhered to the toner particles can also be prevented.

By applying the above form, the charge amount of the toner particles is controlled regardless of the printing amount or the printing environment, and a desired image density can be maintained.

The electrophotographic toner set including the developer toner and the replenishment toner can suppress a high charge amount by these activities even when the particle diameter of the toner is the lower limit in a low humidity environment or at a stage where the printing amount is small. Further, the deterioration of the carrier due to an increase in the printing amount or the decrease in the charge amount of the toner in a high humidity environment or when the particle diameter of the toner is the upper limit. Therefore, the charge amount of the toner can be controlled regardless of the printing amount, and a toner capable of maintaining a desired image density can be provided.

### (Method for Producing Electrophotographic Toner Set)

Next, a method for producing the electrophotographic toner set including the developer toner and the replenishment toner will be described.

First, the toner particles containing the color developable compound and the color developing agent are produced. The toner particles are preferably formed into microcapsules by encapsulating the core component containing the color developable compound, the color developing agent, and the decolorizing agent with the shell component. By forming the toner particles into the microcapsules, the coloring and decolorizing activity of the toner particles is improved.

Examples of the encapsulation method include an interfacial polymerization method, a coacervation method, an in-situ polymerization method, an in-liquid drying method, and an in-liquid curing coating method. In particular, an in-situ polymerization method using a melamine resin as the shell component, or an interfacial polymerization method using a urethane resin as the shell component is preferred.

When encapsulation is performed by an in-situ polymerization method, first, the color developable compound, the color developing agent, and the decolorizing agent are dissolved and mixed, and then emulsified in a water-soluble polymer or a surfactant aqueous solution. Thereafter, a melamine-formalin prepolymer aqueous solution is added thereto, followed by heating to effect polymerization, whereby encapsulation can be achieved.

When encapsulation is performed by an interfacial polymerization method, the above-mentioned three components and a polyvalent isocyanate prepolymer are dissolved and mixed, and then emulsified in a water-soluble polymer or a surfactant aqueous solution. Thereafter, a polyvalent base such as a diamine or a diol is added thereto, followed by heating to effect polymerization, whereby encapsulation can be achieved.

Subsequently, a dispersion liquid of decolorizable color material fine particles, and a dispersion liquid of fine particles containing a binder resin, and according to need, fine particles containing a release agent are mixed. During this mixing, according to need, an aggregating agent such as ammonium sulfate is added, followed by heating to aggregate the fine particles. It is preferred to promote the fusion of the aggregated particles by adding a fusion stabilizing agent such as a sodium polycarboxylate aqueous solution as needed, and then, gradually increasing the temperature to about 100° C. while stirring.

Subsequently, the aggregated and fused toner particles are washed with an aqueous medium such as water. Examples of the washing method which can be used in this embodiment include a centrifugation method and a filter press method. Among these, particularly, a filter press method is preferred since an air blow can be performed while performing compression, and therefore, the amount of water (the water content) of the toner cake after washing can be easily made to fall within the predetermined range.

The toner cake after being subjected to washing is dried until the amount of water (the water content) is decreased to 0.1 to 2 mass %. Examples of the drying method which can be used in this embodiment include a tray-type decompression drying method, a Nauta-type decompression drying method, a conical-type decompression drying method, a vibrating fluid method, and a flash jet method. Among these, particularly, a flash jet method is preferred since the method has high production efficiency.

In order to adjust the fluidity or chargeability, the surface-treated silica particles and titania particles of this embodiment are externally added to the toner particles after being subjected to drying. In this embodiment, hereafter, the toner particles which do not have the silica particles or the titania particles on the surfaces before adding the silica particles and the titania particles are particularly also referred to as “toner mother particles”. In this embodiment, the external additive containing both silica particles and titania particles as described above is added to the developer toner and the replenishment toner so as to satisfy the above-mentioned predetermined content relationship. Further, according to need, another external additive may be added. By the addition thereof in predetermined amounts, the developer toner and the replenishment toner are produced, respectively.

The toner set of this embodiment is a toner set including the developer toner and the replenishment toner. The developer toner and the replenishment toner may be configured to combine an arbitrary number of toners in arbitrary forms. For example, in order to use the toner set in the below-mentioned image forming apparatus, the toner set may be a toner kit in which the developer toner to be initially filled in the image forming apparatus and the replenishment toner to be replenished later are combined. The developer toner or the replenishment toner may be supplied in an arbitrary form. For example, the developer toner or the replenishment toner may be housed in a toner cartridge as described below. Further, the developer toner may be housed in a developing device. In this case, the developer toner is housed in the developing device along with a carrier and is used as an initial toner. After starting image formation, as the toner in the developer is consumed, a new toner as the replenishment toner is replenished to the developing device from the toner cartridge attached to the image forming apparatus. The charge amount of the developer toner is likely to be significantly increased during the period of initial use from when the developer toner is started to be used along with the carrier to when the number of printed sheets of paper reaches about several hundreds. The external additive for the developer is require to prevent the increase in the charge amount during this specific period.

### (Toner Cartridge Set)

Hereinafter, a toner cartridge set of this embodiment will be described.

The toner cartridge set of this embodiment includes a toner cartridge in which the developer toner of the electrophotographic toner set is housed in a container and a toner cartridge in which the replenishment toner of the electrophotographic toner set is housed in a container.

By using the toner cartridge set of this embodiment in an image forming apparatus, a favorable image in which scattering of the toner particles and fixing failure are prevented, and also a constant image density can be maintained can be stably obtained.

The toner cartridge set of this embodiment may be a toner set including a toner cartridge in which the developer toner is housed and a toner cartridge in which the replenishment toner is housed.

Alternatively, the toner cartridge set of this embodiment may include only a toner cartridge in which the replenishment toner is housed. In this case, the replenishment toner, in which the contents of the silica particles and the titania particles of the replenishment toner are adjusted to satisfy the above-mentioned relationship with respect to the contents of the silica particles and the titania particles of the developer toner, is supplied to the image forming apparatus.

### (Image Forming Apparatus)

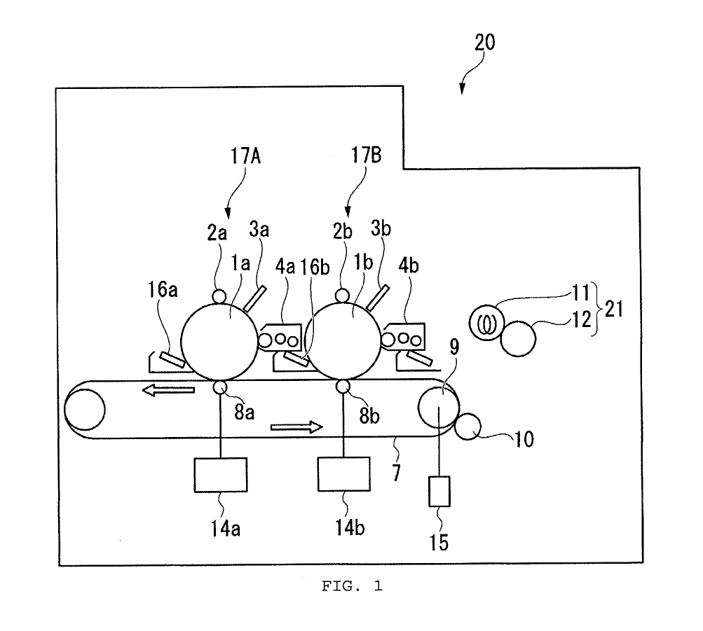

Hereinafter, an image forming apparatus of an embodiment will be described with reference to FIG. 1.

The image forming apparatus of the embodiment is configured such that the electrophotographic toner set of the above-mentioned embodiment is housed in an apparatus main body. As the apparatus main body, a general electrophotographic apparatus can be used.

The FIGURE is a diagram showing an outline structure of the image forming apparatus of this embodiment.

An image forming apparatus 20 includes an apparatus main body including an intermediate transfer belt 7, and a first image forming unit 17A and a second image forming unit 17B which are provided sequentially on the intermediate transfer belt 7, and a fixing device 21 provided downstream of these members. The first image forming unit 17A is provided downstream of the second image forming unit 17B along the moving direction of the intermediate transfer belt 7, that is, the proceeding direction of the image forming process. The fixing device 21 is provided downstream of the first image forming unit 17A.

The first image forming unit 17A includes a photoconductive drum 1a, and a cleaning device 16a, a charging device 2a, an exposure device 3a, and a first developing device 4a, which are provided sequentially on the photoconductive drum 1a, and a primary transfer roller 8a provided to face the photoconductive drum 1a through the intermediate transfer belt 7.

The second image forming unit 17B includes a photoconductive drum 1b, and a cleaning device 16b, a charging device 2b, an exposure device 3b, and a second developing device 4b, which are provided sequentially on the photoconductive drum 1b, and a primary transfer roller 8b provided to face the photoconductive drum 1b through the intermediate transfer belt 7.

In the first developing device 4a and the second developing device 4b, a developer containing the developer toner of this embodiment described above is housed. This toner may be configured to be supplied from a toner cartridge (not shown) in which the developer toner is housed. Further, the first developing device 4a and the second developing device 4b are configured such that the replenishment toner of this embodiment described above can be supplied thereto. Although not shown in the drawing, a configuration in which a toner cartridge in which the replenishment toner is housed is formed connectably, and the replenishment toner is supplied may be adopted.

To the primary transfer roller 8a, a primary transfer power supply 14a is connected. To the primary transfer roller 8b, a primary transfer power supply 14b is connected.

On the downstream side of the first image forming unit 17A, a secondary transfer roller 9 and a backup roller 10 are disposed to face each other through the intermediate transfer belt 7. To the secondary transfer roller 9, a second transfer power supply 15 is connected.

The fixing device 21 includes a heat roller 11 and a press roller 12 disposed to face each other.

An image forming method for performing image formation can be performed, for example, as follows using the image forming apparatus 20.

First, the photoconductive drum 1b is uniformly charged by the charging device 2b. Then, light exposure is performed by the exposure device 3b, thereby forming an electrostatic latent image on the photoconductive drum 1b. Then, the electrostatic latent image is developed with the toner supplied from the developing device 4b, thereby obtaining a second toner image.

Subsequently, the photoconductive drum 1a is uniformly charged by the charging device 2a. Then, light exposure is performed based on first image information (second toner image) by the exposure device 3a, thereby forming an electrostatic latent image on the photoconductive drum 1a. Then, the electrostatic latent image is developed with the toner supplied from the developing device 4a, thereby obtaining a first toner image.

The second toner image and the first toner image are transferred in this order onto the intermediate transfer belt 7 using the primary transfer rollers 8a and 8b.

An image obtained by stacking the second toner image and the first toner image in this order on the intermediate transfer belt 7 is secondarily transferred onto a recording medium (not shown) through the secondary transfer roller 9 and the backup roller 10. By doing this, an image in which the first toner image and the second toner image are stacked in this order is formed on the recording medium.

The types of the colorants used in the toner in the developing device 4a and the developing device 4b are arbitrarily selected. The image forming apparatus 20 shown in the FIGURE includes two developing devices, however, may include three or more developing devices depending on the types of the toners to be used.

When replenishing the toner to this image forming apparatus, the replenishment toner is replenished using the toner cartridge in which the replenishment toner is housed in the toner cartridge set using the electrophotographic toner set of this embodiment.

According to the image forming apparatus of this embodiment, a favorable image in which scattering of the toner particles and fixing failure are prevented, and also a constant image density can be maintained can be stably obtained.

### EXAMPLE

The following example is described as an example of the embodiment. However, the embodiment is not construed as being limited to this example.

### (Preparation of Resin Particle Dispersion)

A dispersion liquid obtained by mixing 30 parts by mass of a polyester resin (acid value: 10 mg KOH/g, Mw: 15000, Tg: 58° C.), 1 part by mass of sodium dodecylbenzene sulfonate (Neopelex G-15, manufactured by Kao Corporation), and 69 parts by mass of ion exchanged water and adjusting the pH to 12 with potassium hydroxide was placed in a high-pressure homogenizer NANO 3000 (manufactured by Beryu Co., Ltd.), and processed at 150° C. and 150 MPa, whereby a resin particle dispersion was obtained. When the dispersion diameter of the thus obtained resin particle dispersion was measured using SALD-7000 manufactured by Shimadzu Corporation, the resin particle dispersion had a dispersion diameter of 0.23 μm and had a sharp particle size distribution with a standard deviation of 0.15.

### (Preparation of Colorant Particle Dispersion)

Components including 2 parts by mass of 3-(4-diethylamino-2-hexyloxyphenyl)-3-(1-ethyl-2-methylindol-3-yl)-4-azaphthalide as a leuco dye, 4 parts by mass of 1,1-bis(4′-hydroxyphenyl)hexafluoropropane and 4 parts by mass of 1,1-bis(4′-hydroxyphenyl)-n-decane as color developing agents, and 50 parts by mass of 4-benzyloxyphenylethyl caprylate as a decolorizing agent were uniformly dissolved by heating. The obtained mixture was mixed with 30 parts by mass of an aromatic polyvalent isocyanate prepolymer and 40 parts by mass of ethyl acetate as encapsulating agents. The obtained solution was emulsified and dispersed in 300 parts by mass of an aqueous solution of 8% polyvinyl alcohol, and the resulting dispersion was kept stirred at 70° C. for about 1 hour. Thereafter, 2.5 parts by mass of a water-soluble aliphatic modified amine was added thereto as a reaction agent, and stirring was further continued for an additional 6 hours, whereby colorless capsule particles were obtained. Then, the resulting capsule particle dispersion was placed in a freezer (−30° C.) to develop a color, and ion exchanged water was added thereto, whereby a 27 wt % colorant particle dispersion was obtained. When the obtained fine particle dispersion was measured using SALD-7000 manufactured by Shimadzu Corporation, the dispersion had a dispersion diameter of 3.3 μm.

### (Preparation of Release Agent Particle Dispersion)

A dispersion liquid obtained by mixing 20 parts by mass of carnauba wax, 1 part by mass of dipotassium alkenyl sulfosuccinate (LATEMUL ASK, manufactured by Kao Corporation), and 79 parts by mass of ion exchanged water was placed in a rotor-stator homogenizer CLEAR MIX 2.2S (manufactured by M Technique Co., Ltd.), and the temperature of the dispersion liquid was increased to 100° C. while stirring at 1000 rpm, whereby a release agent particle dispersion was obtained. When the volume average particle diameter of the obtained release agent particle dispersion was measured using SALD-7000 manufactured by Shimadzu Corporation, the release agent particle dispersion had a volume average particle diameter of 0.5 μm.

### (Preparation of Toner Mother Particles)

The colorant particle dispersion (42 parts by mass) and ion exchanged water (63 parts by mass) were mixed, and 50 parts by mass of a 30% ammonium sulfate solution was added thereto while stirring, and the resulting mixture was maintained as such for 1 hour. Then, 14 parts by mass of the release agent particle dispersion was added thereto, and the temperature of the mixture was increased to 30° C., whereby a first aggregate dispersion liquid having a volume average particle diameter of 6.2 μm was prepared.

Further, 300 parts by mass of the resin particle dispersion in which the solid content concentration was adjusted to 15% was gradually added thereto over 10 hours, whereby a toner composition aggregate dispersion liquid (a second aggregate dispersion liquid) having a volume average particle diameter of 9.3 μm (Cv value: 16.5) was obtained. Further, to the toner composition aggregate dispersion liquid, 5 parts by mass of a polycarboxylic acid-based surfactant (POISE 520, manufactured by Kao Corporation) was added as a surfactant, and then, the resulting mixture was heated to 60° C. and left as such, whereby a toner dispersion liquid was obtained. The obtained toner dispersion liquid was washed by repeatedly performing filtration and washing with ion exchanged water until the electrical conductivity of the filtrate was decreased to 50 μS/cm. Thereafter, the resulting residue was dried using a vacuum dryer until the water content therein was decreased to 1.0 mass % or less, whereby toner mother particles after drying were obtained. The BET value of the toner mother particles after drying was 3.9 m²/g.

### Examples 1 to 5

PDMS-treated silica (average primary particle diameter: 30 nm, BET specific surface area: 30±10 m²/g), HMDS-treated silica, and titania (treated with RS, average primary particle diameter: 14 nm, BET specific surface area: 65±15 m²/g) were mixed with the above-prepared toner mother particles after drying according to the formulation shown in Table 1 using a Henschel Mixer, whereby toner particles to which silica particles and titania particles were externally added were obtained. The contents of the silica particles and the titania particles are represented by values in parts by mass when the amount of the toner particles was taken as 100 parts by mass in each of the developer toner and the replenishment toner. Each Example is an electrophotographic toner set including the developer toner and the replenishment toner, each containing the silica particles and the titania particles at a content shown in Table 1. In Table 1, with respect to the respective particles of PDMS silica, HMDS silica (corresponding to another silica) and titania included in the electrophotographic toner set, the contents of these particles contained in the developer toner and the replenishment toner are shown together.

A developer was produced by mixing the toner particles produced according to the formulation shown in Table 1 and a ferrite carrier having an average particle diameter of 40 nm at a toner ratio concentration of 9%. The replenishment toner is filled in a toner cartridge, and as the image forming apparatus, an MFP (Loops LP301) manufactured by Toshiba Tec Corporation modified for evaluation was used. Paper (250,000 sheets) was allowed to pass through the apparatus at a printing rate of 2% (evaluation was performed in an environment at 10° C. and 20% RH at an initial stage, and in an environment at 30° C. and 85% RH in the latter half of the life). The evaluation results are shown in Table 1.

### Comparative Examples 1 to 4

In the same manner as in Examples 1 to 5, toner particles to which external additives were added were obtained according to the formulation shown in Table 1, and electrophotographic toner sets including the developer toner and the replenishment toner of Comparative Examples 1 to 4 were prepared. Further, evaluation was performed in the same manner as in Examples 1 to 5. The evaluation results are shown in Table 1.

TABLE 1

| | PDMS silica | | | | | Total silica | | |
|---|---|---|---|---|---|---|---|---|
| | | | Ratio | | | | | Ratio |
| | | | (developer | | | | | (developer |
| | | | toner/ | HMDS silica | | | | toner/ |
| | Developer | Replenishment | replenishment | Developer | Replenishment | Developer | Replenishment | replenishment |
| | toner | toner | toner) | toner | toner | toner | toner | toner) |
| Example 1 | 1.68 | 2.10 | 0.80 | 1.28 | 1.60 | 2.96 | 3.70 | 0.80 |
| Example 2 | 2.00 | 2.10 | 0.95 | 1.52 | 1.60 | 3.52 | 3.70 | 0.95 |
| Example 3 | 2.00 | 2.10 | 0.95 | 1.52 | 1.60 | 3.52 | 3.70 | 0.95 |
| Example 4 | 1.05 | 2.10 | 0.50 | 0.80 | 1.60 | 1.85 | 3.70 | 0.50 |
| Example 5 | 1.05 | 2.10 | 0.50 | 0.80 | 1.60 | 1.85 | 3.70 | 0.50 |
| Comparative | 2.10 | 2.10 | 1.00 | 1.60 | 1.60 | 3.70 | 3.70 | 1.00 |
| Example 1 | | | | | | | | |
| Comparative | 0.00 | 0.00 | — | 1.00 | 1.00 | 1.00 | 1.00 | 1.00 |
| Example 2 | | | | | | | | |
| Comparative | 2.10 | 2.10 | 1.00 | 1.60 | 1.60 | 3.70 | 3.70 | 1.00 |
| Example 3 | | | | | | | | |
| Comparative | 1.00 | 2.10 | 0.48 | 0.76 | 1.60 | 1.76 | 3.70 | 0.48 |
| Example 4 | | | | | | | | |

| | | | | Evaluation results | |
|---|---|---|---|---|---|
| | Titania | | | | Toner |
| | | | Ratio | Image density | scattering in |
| | | | (developer | at initial | latter half of |
| | | | toner/ | stage in | life in high |
| | Developer | Replenishment | replenishment | low humidity | humidity |
| | toner | toner | toner) | environment | environment |
| Example 1 | 0.84 | 0.30 | 2.80 | 0.55 | No |
| Example 2 | 1.50 | 0.30 | 5.00 | 0.51 | No |
| Example 3 | 0.4 | 0.30 | 1.3 | 0.52 | No |
| Example 4 | 1.50 | 0.30 | 5.00 | 0.57 | No |
| Example 5 | 0.4 | 0.30 | 1.3 | 0.65 | No |
| Comparative | 0.30 | 0.30 | 1.00 | 0.39 | No |
| Example 1 | | | | | |
| Comparative | 0.30 | 0.30 | 1.00 | 0.52 | Yes |
| Example 2 | | | | | |
| Comparative | 1.60 | 0.30 | 5.33 | 0.31 | No |
| Example 3 | | | | | |
| Comparative | 0.30 | 0.30 | 1.00 | 0.59 | Yes |
| Example 4 | | | | | |

According to the formulation ratio of the external additives, in the case of Examples 1 to 5 in which the contents of the silica particles and the titania particles were made to fall within the ranges of this embodiment, problems such as a low image density and toner scattering did not occur particularly. However, in the case of the toner sets in which the external additives were added at ratios outside the ranges of this embodiment, the image density was low and toner scattering occurred. In the case of Comparative Examples 1 and 3, due to a low humidity environment and the initial stage of printing, the charge amount was increased, and the image density was decreased. In the case of Comparative Examples 2 and 4, due to a high humidity environment and the latter half of printing, the charge amount was decreased by carrier contamination, and therefore, it is considered that scattering occurred.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fail within the scope and spirit of the inventions.

What is claimed is:

1. An electrophotographic toner set comprising a developer toner and a replenishment toner, wherein
the developer toner and the replenishment toner each include toner particles, with silica particles and titania particles provided on a surface of the toner particles,
the silica particles have a BET specific surface area in a range of 15 m²/g to 95 m²/g, and are surface-treated with a silicone oil,
the titania particles have a BET specific surface area in a range of 30 m²/g to 65 m²/g,
the content W_{S1} in parts by mass of the silica particles with respect to 100 parts by mass of the toner particles of the developer toner and the content W_{S2} in parts by mass of the silica particles per total mass of the replenishment toner satisfy the following relationship: 0.5≤(W_{S1}/W_{S2})<1.0, and
the content W_{T1} in parts by mass of the titania particles with respect to 100 parts by mass of the toner particles of the developer toner and the content W_{T2} in parts by mass of the titania particles per total mass of the replenishment toner satisfy the following relationship: 1.0<(W_{T1}/W_{T2})≤5.0.

2. The set according to claim 1, wherein in the developer toner, the content W_{S1} of the silica particles and the content W_{T1} of the titania particles satisfy the following relationship: 0.5<(W_{S1}/W_{T1})≤5.0.

3. The set according to claim 1, wherein in the replenishment toner, the content W_{S2} of the silica particles and the content W_{T2} of the titania particles satisfy the following relationship: 6.0<(W_{S2}/W_{T2})<8.0.

4. An image forming apparatus, comprising the electrophotographic toner set according to claim 1, wherein the developer toner is housed in the electrophotographic toner set, and the replenishment toner is supplied to the electrophotographic toner set.

5. The image forming apparatus according to claim 4, wherein in the developer toner, the content W_{S1} of the silica particles and the content W_{T1} of the titania particles satisfy the following relationship: 0.5<(W_{S1}/W_{T1})≤5.0.

6. The image forming apparatus according to claim 4, wherein in the replenishment toner, the content W_{S2} of the silica particles and the content W_{T2} of the titania particles satisfy the following relationship: 6.0<(W_{S2}/W_{T2})<8.0.

7. An image forming method, comprising performing image formation using the image forming apparatus according to claim 4.

8. An image forming method, comprising:
providing an image forming apparatus including the electrophotographic toner set according to claim 1, the image forming apparatus performing:
(a) uniformly charging a first photoconductive drum by a first charging device;
(b) forming a first electrostatic latent image on the first photoconductive drum by light exposure from a first exposure device;
(c) developing the first electrostatic latent image with toner from a first developing device to forma first toner image.

9. The image forming method according to claim 8, further comprising:
(d) uniformly charging a second photoconductive drum by a second charging device;
(e) forming a second electrostatic latent image on the second photoconductive drum by light exposure from a second exposure device;
(f) developing the second electrostatic latent image with toner from a second developing device to form a second toner image.

10. The image forming method according to claim 9, further comprising:
(g) forming an image by stacking the first toner image and the second toner image;
(h) transferring the stack onto an intermediate transfer belt using at least one primary transfer roller;
(i) transferring the stack from the intermediate transfer belt onto a recording medium using a secondary transfer roller and a backup roller.

11. The image forming method according to claim 9, wherein the first developing device and the second developing device each include the electrophotographic toner set such that both the developer toner and the replenishment toner are housed in the electrophotographic toner set.
